(19) United States
(12) Patent Application Publication
(10) Pub. No.: US 2024/0167635 A1
(43) Pub. Date: May 23, 2024

(54) HIGH-PRESSURE TANK

(71) Applicant: TOYOTA JIDOSHA KABUSHIKI KAISHA, Toyota-shi (JP)

(72) Inventor: Manabu Fujii, Toyota-shi (JP)

(73) Assignee: TOYOTA JIDOSHA KABUSHIKI KAISHA, Toyota-shi (JP)

(21) Appl. No.: 18/461,621

(22) Filed: Sep. 6, 2023

(30) Foreign Application Priority Data
Nov. 22, 2022 (JP) 2022-186349

(51) Int. Cl. F17C 13/04

(52) U.S. Cl. CPC F17C 13/04; F17C 2205/0305; F17C 2205/0382; F17C 2223/035

(57) ABSTRACT

The high-pressure tank includes a tank body, a boss, a valve body that is housed in a through hole, and a ring-shaped seal provided on an outer peripheral surface of the valve body. The outer peripheral surface of the valve body has a groove portion in which a seal is disposed along the axial direction of the valve body, and a thick shaft portion adjoining the groove portion from an inside space side and having a diameter larger than that of the groove portion. In a stroke in which the valve body moves from an open position to a closed position, when the position of the valve body when the compression of the seal is started is defined as the compression start position, the length of the thick shaft portion is larger than the distance from the compression start position to the closed position.

### CROSS-REFERENCE TO RELATED APPLICATION

This application claims priority to Japanese Patent Application No. 2022-186349 filed on Nov. 22, 2022, incorporated herein by reference in its entirety.

### BACKGROUND

### 1. Technical Field

The technique disclosed in the present specification relates to high-pressure tanks. In particular, the technique disclosed in the present specification relates to a high-pressure tank in which a valve body closes a through hole of a boss.

### 2. Description of Related Art

Japanese Unexamined Patent Application Publication No. 2014-031830 (JP 2014-031830 A) discloses a sealing structure including a tank body, a valve body, a boss, and a ring-shaped seal (e.g., an O-ring). The seal is housed in a housing region formed by the outer peripheral surface of the valve body and the inner peripheral surface of a through hole of the boss, and seals a fluid. The through hole of the boss allows the inside and outside spaces of the tank body to communicate with each other. The valve body moves between an open position and a closed position in the axial direction of the through hole. The open position is a position where the through hole of the boss is opened, and the closed position is a position where the through hole is closed. The valve body includes a groove portion and a thick shaft portion along the axial direction of the valve body. The groove portion is a portion where the seal is located, and the thick shaft portion is a portion adjoining the groove portion from the inside space side of the tank body and having a larger diameter than the groove portion.

### SUMMARY

When the valve body moves from the open position to the closed position, the tip end of the outer peripheral surface of the thick shaft portion comes into contact with the inner peripheral surface of the through hole, and the tip end may scratch the inner peripheral surface. The seal closes the through hole in a compressed state between the groove portion of the valve body and the inner peripheral surface of the through hole. Therefore, when the inner peripheral surface of the through hole has a scratch, the seal is strongly pressed against the scratch. As a result, the seal may be damaged. In the present specification, a technique is provided that can eliminate or reduce the possibility of damage to a seal in a high-pressure tank in which a valve body closes a through hole of a boss.

A high-pressure tank disclosed in the present specification includes: a tank body having an inside space configured to contain a fluid; a boss located on the tank body and having a through hole that allows the inside space and an outside space of the tank body to communicate with each other; a valve body housed in the through hole and movable between an open position and a closed position in an axial direction of the through hole, the open position being a position where the through hole is opened, and the closed position being a position where the through hole is closed; and a ring-shaped seal located on an outer peripheral surface of the valve body. The outer peripheral surface of the valve body includes, along an axial direction of the valve body, a groove portion where the seal is located, and a thick shaft portion adjoining the groove portion from the inside space side and having a larger diameter than the groove portion. A length of the thick shaft portion is greater than a distance from a compression start position to the closed position, the compression start position being defined as a position where compression of the seal is started in a stroke in which the valve body moves from the open position to the closed position. The length of the thick shaft portion herein means a dimension from a proximal end of the thick shaft portion that is located proximal to the groove portion to a distal end of the thick shaft portion that is located distal to the groove portion.

When the valve body moves from the open position to the closed position, the ring-shaped seal is compressed between an inner peripheral surface of the through hole and the outer peripheral surface of the valve body. When the seal is compressed, a reaction force is applied from the seal to the valve body along the entire circumference of the seal. A frictional force generated between an outer peripheral surface of the seal and the inner peripheral surface of the through hole may be uneven in the circumferential direction of the seal. As a result, the seal is compressed in some circumferential regions of the seal but is pulled in other circumferential regions of the seal. The reaction force applied from the seal to the valve body is large in the regions where the seal is compressed. The reaction force applied from the seal to the valve body is small in the regions where the seal is pulled. That is, the reaction force applied from the seal to the valve body may be uneven in the circumferential direction of the seal. When the reaction force of the seal becomes uneven, the valve body becomes eccentric with respect to the through hole. In this case, in the stroke in which the valve body moves further toward the closed position, the distal end of the thick shaft portion comes into strong contact with the inner peripheral surface of the through hole. which may scratch the inner peripheral surface of the through hole. That is, the section where the inner peripheral surface of the through hole may be damaged is a section the distal end of the thick shaft portion of the valve body passes while the valve body moves from the compression start position to the closed position.

Based on the above findings, in the technique disclosed in the present specification, the length of the thick shaft portion is made greater than the distance from the compression start position to the closed position. According to such a configuration, the range in which the distal end of the thick shaft portion of the valve body moves while the valve body moves from the compression start position to the closed position does not overlap the range in which the seal moves while the valve body moves from the compression start position to the closed position. Therefore, even if the inner peripheral surface of the through hole gets scratched due to the eccentricity of the valve body, the seal can be avoided from coming into contact with the scratch. That is, the possibility of damage to the seal can be eliminated or reduced.

Details of the technique disclosed in the present specification and further improvements thereof will be described in “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a high-pressure tank of a first embodiment;

FIG. 2A is an enlarged view in the dashed II of FIG. 1;

FIG. 2B shows an enlarged view in the dashed II of FIG. 1;

FIG. 3A is an enlarged view similar to FIG. 2A, showing a high-pressure tank of a second embodiment;

FIG. 3B is an enlarged view similar to FIG. 2B, showing the high-pressure tank of the second embodiment;

FIG. 4A is an enlarged view corresponding to FIG. 2A, showing a high-pressure tank of the prior art; and

FIG. 4B is an enlarged view corresponding to FIG. 2B, showing the high-pressure tank of the prior art.

### DETAILED DESCRIPTION OF EMBODIMENTS

In an embodiment of the present technology, the groove portion may further include along the axial direction of the valve body a second thick shaft portion adjoining the groove portion from the outside space side and having the same diameter as the thick shaft portion. According to such a configuration, due to the step between the groove portion and the second thick shaft portion, the seal compressed by the inner peripheral surface of the through hole is less likely to be pushed out from the groove portion toward the outside space side when the valve body moves from the compression start position to the closed position.

In an embodiment of the present technology, a distal end of the thick shaft portion located distal to the groove portion may be chamfered. According to such a configuration, when the valve body moves from the compression start position to the closed position, the chamfered surface interferes with the inner peripheral surface of the through hole. Therefore, the inner peripheral surface of the through hole is less likely to be scratched.

In an embodiment of the present technology, the inner peripheral surface of the through hole may have a first section having a first diameter along the axial direction of the through hole and in which the seal abuts in the closed position, and a second section adjoining the first section from the inside space side and having a diameter larger than the first diameter. In this case, the distal end of the thick shaft portion located distal to the groove portion may face the second section of the through hole even when the valve body is in either the closed position or the compression start position. According to such a configuration, in a stroke in which the valve body is between the closed position and the compression start position, at least the distal end of the thick shaft portion of the valve body faces the second section having a diameter larger than the first diameter. As a result, the distance between the distal end of the thick shaft portion and the second section increases in the stroke in which the valve body is between the closed position and the compression start position, and thus the contact between the distal end and the inner peripheral surface of the through hole can be suppressed. Therefore, the inner peripheral surface of the through hole is less likely to be scratched.

In an embodiment of the present technology, an end of the first section that is located at a boundary between the first section and the second section may be chamfered. According to such a configuration, when the valve body moves between the compression start position and the closed position, the chamfered surface interferes with the outer peripheral surface of the thick shaft portion of the valve body. The outer peripheral surface of the thick shaft portion is therefore less likely to be scratched.

### First Embodiment

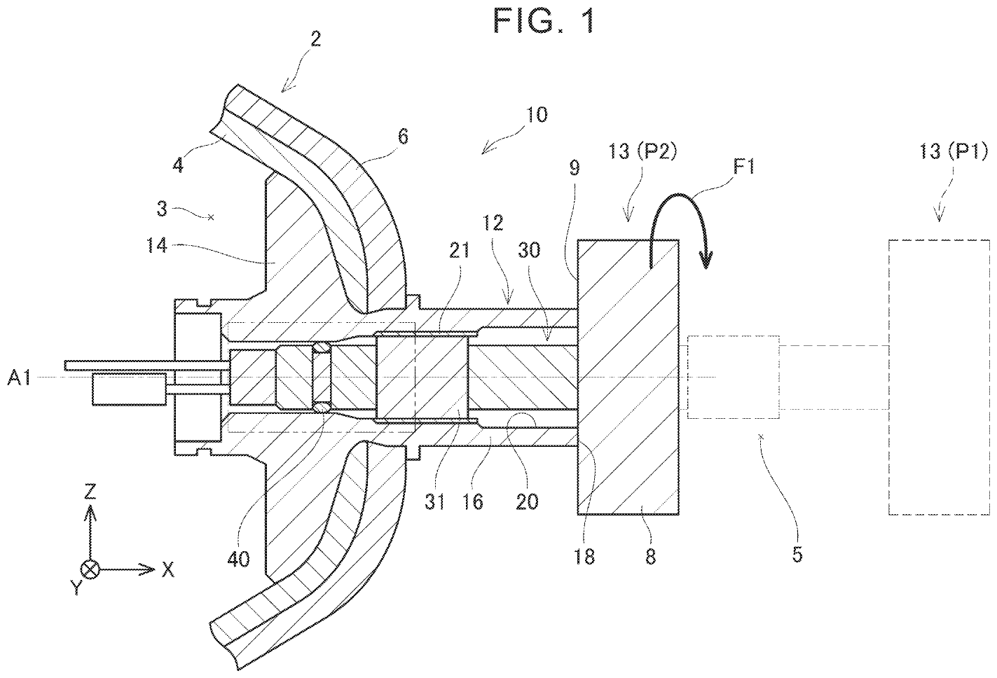

A high-pressure tank of a first embodiment will be described with reference to the drawings. FIG. 1 shows a partial cross-sectional view of a high-pressure tank 10 of the first embodiment. The high-pressure tank 10 includes a tank body 2, a boss 12, a valve body 13, and a seal 40. The high-pressure tank 10 is a tank containing high-pressure hydrogen (i.e., fluid), and is mounted on, for example, a fuel cell electric vehicle. The high-pressure tank 10 has a cylindrical shape extending in the X-axis direction (i.e., the left-right direction in FIG. 1). In FIG. 1, only one end of the high-pressure tank 10 is shown. In the following description, the tank body 2 side of the high-pressure tank 10 (that is, the left side in FIG. 1) may be referred to as “inner side”, and the opposite boss 12 side may be referred to as “outer side”.

The tank body 2 includes a liner 4 and a reinforcing layer 6. The tank body 2 has a cylindrical shape extending in the X-axis direction (i.e., the left-right direction in FIG. 1). Both ends of the tank body 2 in the X-axis direction bulge in a dome shape. The liner 4 is a resin component that forms an inside space 3 containing hydrogen. The reinforcing layer 6 is made of, for example, a carbon fiber reinforced resin, and covers the 30 liner 4 from the outside. As a result, the tank body 2 can contain the high-pressure hydrogen in the inside space 3.

The boss 12 is provided at an end portion of the tank body 2 on the positive side in the X-axis direction (that is, the right side in the drawing of FIG. 1). The boss 12 includes a base portion 14 and a cylindrical portion 16. A positive side surface of the base portion 14 in the X-axis direction is covered with a liner 4 of the tank body 2. The cylindrical portion 16 protrudes outward from the reinforcing layer 6 of the tank body 2. The boss 12 has a through hole 20 extending in the X-axis direction across the base portion 14 and the cylindrical portion 16. The through hole 20 communicates the inside space 3 of the tank body 2 with the outside space 5. The inner peripheral surface of the through hole 20 has a hole-side screw section 21. A thread is formed in the hole-side screw section 21.

A valve body 13 is housed in the through hole 20. The valve body 13 includes a handle 8 and a valve rod 30. The outer peripheral surface of the valve rod 30 has a valve-side screw portion 31. The valve-side screw portion 31 is formed with a thread and is threadedly engaged with the thread of the hole-side screw section 21. Thus, for example, when the handle 8 of the valve body 13 rotates in the direction of arrow F1, the valve body 13 moves from the open position P1 toward the inside space 3. When the valve body 13 moves toward the inside space 3 and the end surface 9 of the handle 8 on the side of the inside space 3 and the end portion 18 of the cylindrical portion 16 of the boss 12 on the side of the outside space 5 come into contact with each other, the valve body 13 closes the through hole 20. On the other hand, when the handle 8 rotates in the opposite-direction of the arrow F1, the valve body 13 moves from the closed position P2 where the through hole 20 is closed toward the open position P1. As a result, the through hole 20 is opened. As described above, the valve body 13 moves between the open position P1 and the closed position P2 in the direction of the axis A1 of the through hole 20.

The seal 40 is a ring-shaped member having elasticity and is provided on an outer peripheral surface of the valve rod 30 of the valve body 13. The seal 40 is typically a O made of silicone rubber. The seal 40 is compressed between the inner peripheral surface of the through hole 20 and the outer peripheral surface of the valve rod 30, thereby sealing between the inner peripheral surface of the through hole 20 and the outer peripheral surface of the valve rod 30. The cross-sectional shape of the seal 40 is not limited to a circular shape. In a variation, the seal 40 may employ a square ring instead of a O ring.

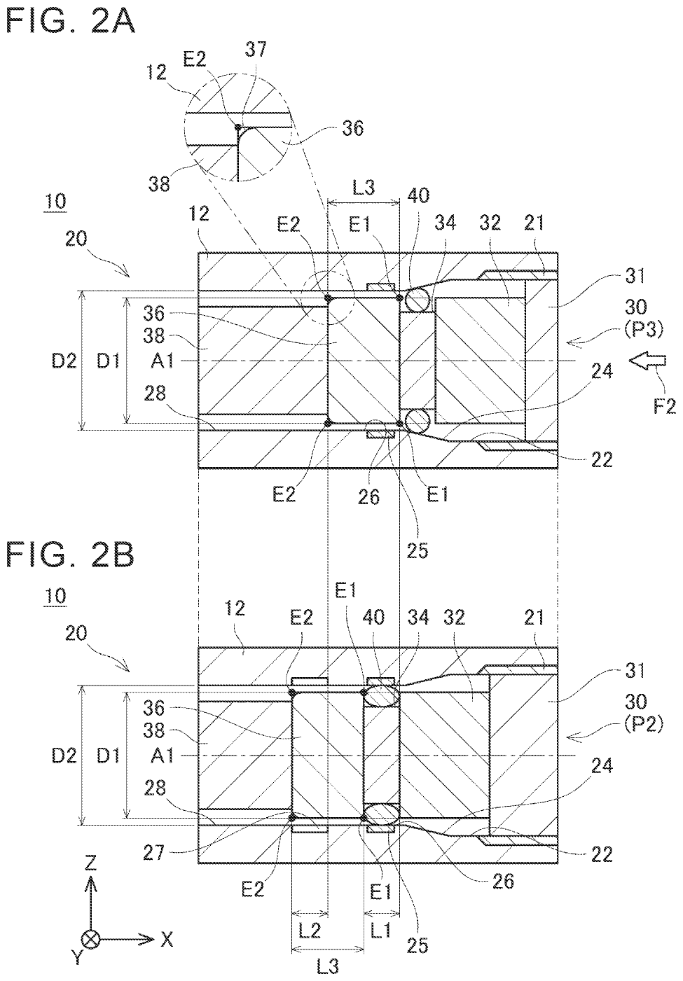

Referring to FIGS. 2A and 2B, a detailed configuration of the through hole 20 of the boss 12 and the valve rod 30 of the valve body 13 will be described. FIGS. 2A and 2B show an enlarged view of the area surrounded by the dashed II of FIG. 1. FIG. 2A shows the positional relation between the through hole 20 and the valve rod 30 at the timing when the seal 40 of the valve body 13 starts contacting the inner peripheral surface of the through hole 20 in the stroke in which the valve body 13 moves from the open position PI to the closed position P2. That is, 2A shows the positional relation between the through hole 20 and the valve rod 30 at the timing at which the seal 40 starts to compress. In the present specification, the position of the valve body 13 at which the seal 40 starts compression in the stroke in which the valve body 13 moves from the open position P1 to the closed position P2 is defined as the compression start position P3. That is, 2A shows the positional relation between the through hole 20 and the valve rod 30 at the timing the valve body 13 is positioned at the compression start position P3 in the stroke in which the valve body 13 moves from the open position P1 to the closed position P2. On the other hand, FIG. 2B shows the positional relation between the through hole 20 and the valve rod 30 at the timing when the valve body 13 is positioned at the closed position P2. In the closed position P2 shown in the drawing 2B, the seal 40 abuts the seal compression section 25. Note that, in FIGS. 2A and 2B, the axis A1 of the through hole 20 and the axis of the valve body 13 are described as being coaxial.

The inner peripheral surface of the through hole 20 has, in addition to the hole-side screw section 21, a large-diameter section 22, a guide section 24, a first small-diameter section 26, and a second small-diameter section 28 along the direction of the axis A1. The large-diameter section 22 adjoins the hole-side screw section 21 from the inside space 3 side and has substantially the same diameter as the hole-side screw section 21. The guide section 24 has a curved surface that adjoins the large-diameter section 22 from the inside space 3 side and that is inclined so as to approach the center of the through hole 20 toward the inside space 3 side. The first small-diameter section 26 adjoins the guide section 24 from the inside space 3 and has a smaller diameter D2 than the large-diameter section 22. The second small-diameter section 28 adjoins the first small-diameter section 26 from the inside space 3 and has the same diameter D2 as the first small-diameter section 26.

The outer peripheral surface of the valve rod 30 of the valve body 13 has, along the direction of the axis A1, an outer thick shaft portion 32, a groove portion 34, an inner thick shaft portion 36, a chamfered portion 37, and an intermediate shaft portion 38, in addition to the valve-side screw portion 31. The outer thick shaft portion 32 adjoins the valve-side screw portion 31 from the inside space 3 side and has a smaller radial D1 than the valve-side screw portion 31. The groove portion 34 adjoins the outer thick shaft portion 32 from the inside space 3 side and has a diameter smaller than the diameter D1 of the outer thick shaft portion 32. A seal 40 is disposed in the groove portion 34. The inner thick shaft portion 36 adjoins the groove portion 34 from the inside space 3 side and has a larger radial D1 than the groove portion 34. The inner thick shaft portion 36 has a proximal end E1 located proximal to the groove portion 34 and a distal end E2 located distal to the groove portion 34. As shown in the FIGS. 2A and 2B, the length L3 of the inner thick shaft portion 36 refers to the dimension from the proximal end E1 to the distal end E2.

The outer thick shaft portion 32 and the inner thick shaft portion 36 have the same radial D1. As described above, the valve body 13 has the outer thick shaft portion 32 that adjoins the groove portion 34 from the outside space 5 side and that has the same radial D1 as the inner thick shaft portion 36. That is, a step is formed at the boundary between the groove portion 34 and the outer thick shaft portion 32. Accordingly, when the valve body 13 moves from the compression start position P3 toward the closed position P2. the seal 40 compressed in the first small-diameter section 26 of the through hole 20 is less likely to be pushed out from the groove portion 34. Similarly, due to the step at the boundary between the groove portion 34 and the inner thick shaft portion 36, the seal 40 is less likely to be pushed out from the groove portion 34 when the valve body 13 moves from the closed position P2 toward the compression start position P3.

Further, in the present embodiment, when the valve rod 30 is manufactured, the outer thick shaft portion 32 and the inner thick shaft portion 36 are simultaneously processed. Thus, it is possible to reduce the difference in the outer diameter between the outer thick shaft portion 32 and the inner thick shaft portion 36, and to reduce the deviation between the center of the outer thick shaft portion 32 and the center of the inner thick shaft portion 36.

Further, the radial D1 of the outer thick shaft portion 32 and the inner thick shaft portion 36 is set such that the gap between the outer peripheral surface of the outer thick shaft portion 32 and the inner thick shaft portion 36 and the inner peripheral surface of the first small-diameter section 26 of the through hole 20 is minimized, taking into account manufacturing variation of the through hole 20, manufacturing variation of the valve rod 30, etc. Thus, the seal 40 can be brought closer to the inner peripheral surface of the first small-diameter section 26 without reducing the step between each of the thick shaft portions 32 and 36 and the groove portion 34. Accordingly, the seal 40 can reliably contact the inner peripheral surface of the first small-diameter section 26. Further, the amount of protrusion of the seal 40 from the outer circumferential surface of the outer thick shaft portion 32 and the inner thick shaft portion 36 can be reduced. Therefore, when the valve body 13 moves between the closed position P2 and the open position P1, the seal 40 can be securely housed in the groove portion 34 due to the step between the groove portion 34 and the outer thick shaft portion 32 and the inner thick shaft portion 36.

As shown in the enlarged view above FIG. 2A, a chamfered portion 37 is formed at the distal end E2 of the inner thick shaft portion 36. The chamfered portion 37 is a so-called R chamfer. In a variant, the chamfered portion 37 may be C-chamfered. The intermediate shaft portion 38 adjoins the inner thick shaft portion 36 from the inside space 3 side and has a diameter smaller than the diameter D1 of the inner thick shaft portion 36. The intermediate shaft portion 38 houses a temperature sensor and an introduction pipe therein.

As shown in the arrow F2 in 2A of the drawing, the valve body 13 further moves from the compression start position P3 toward the closed position P2. At this time, the outer peripheral surface of the seal 40 is compressed with the inner peripheral surface of the guide section 24. As a result, a reaction force acts on the valve rod 30 from the seal 40 over the entire circumference of the compressed seal 40. Here, the frictional force generated between the outer peripheral surface of the seal 40 rotating in the direction of the arrow F1 together with the valve rod 30 and the inner peripheral surface of the guide section 24 may be uneven along the circumferential direction of the seal 40. Also, there may be unavoidable manufacturing errors in the seal 40, such as, for example, cross-sectional shape, material fill factor, etc. As a result, the seal 40 is compressed at some portion of the seal 40 in the circumferential direction and pulled at other portions. At the site where the seal 40 is compressed, the reaction force exerted by the seal 40 on the valve rod 30 increases. At the site where the seal 40 is being pulled, the reaction force exerted by the seal 40 on the valve rod 30 is reduced. That is, the reaction force acting on the valve rod 30 from the seal 40 may be non-uniform along the circumferential direction of the seal 40. As a result, the valve rod 30 is eccentric with respect to the through hole 20.

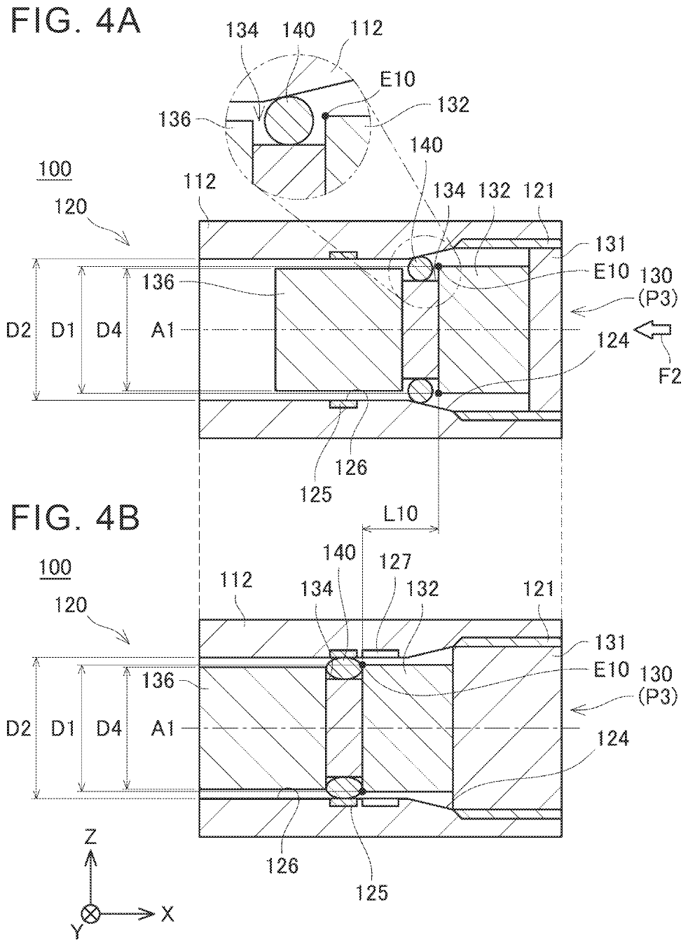

Now, the prior art will be described referring to FIGS. 4A and 4B. FIG. 4A and FIG. 4B show enlarged views corresponding to FIGS. 2A and 2B, respectively, showing a high-pressure tank 100 of the prior art. The high-pressure tank 100 of the prior art includes a boss 112 instead of the boss 12 of the present embodiment. The high-pressure tank 100 includes a valve rod 130 instead of the valve rod 30 of the present embodiment, and includes a seal 140 instead of the seal 40. The boss 112 of the high-pressure tank 100 has a through hole 120. The inner peripheral surface of the through hole 120 has a large-diameter section 122, a guide section 124, and a first small-diameter section 126 in addition to the hole-side screw section 121. The hole-side screw section 121 of the high-pressure tank 100 of the prior art extends inward as compared with the hole-side screw section 21 of the high-pressure tank 10 of the present embodiment. That is, in the high-pressure tank 100 of the prior art, the valve rod 130 enters the inside of the through hole 120 more than the high-pressure tank 10 of the present embodiment. FIG. 4A shows the high-pressure tank 100 of the prior art with the valve body located at the compression start position P3. FIG. 4B shows the high-pressure tank 100 of the prior art with the valve body located at the closed position P2.

The valve rod 130 of the high-pressure tank 100 has a valve-side screw portion 131, an outer thick shaft portion 132, a groove portion 134, and an inner thin shaft portion 136. The outer thick shaft portion 132 has a smaller diameter D1 than the valve-side screw portion 131. The groove portion 134 adjoins the outer thick shaft portion 132 from the inside space 3 side and has a diameter smaller than the diameter D1 of the outer thick shaft portion 132. A seal 140 is disposed in the groove portion 134. As described above, when the valve rod 130 moves inward along the direction of arrow F2, the step at the boundary between the groove portion 134 and the outer thick shaft portion 132 eliminates or reduces the possibility of the seal 140 being pushed out of the groove portion 134.

Therefore, as shown in the enlarged upper view of FIG. 4A, the inner end E10 of the outer thick shaft portion 132 is substantially at a right angle. As a result, as compared with a configuration in which a chamfered shape is provided on the inner end E10 of the outer thick shaft portion 132, it is possible to increase the planar portion of the step at the boundary between the groove portion 134 and the outer thick shaft portion 132. This more reliably eliminates or reduces the possibility of the seal 140 being pushed out of the groove portion 134.

The inner thin shaft portion 136 of the high-pressure tank 100 adjoins the groove portion 134 from the inside space 3 side and has a smaller diameter D4 than the outer thick shaft portion 132. Therefore, the diameter D4 of the inner thin shaft portion 136 of the high-pressure tank 100 is smaller than the diameter D1 of the inner thick shaft portion 36 of the high-pressure tank 10 of the above-described embodiment. This increases the distance between the inner thin shaft portion 136 and the first small-diameter section 126. In the high-pressure tank 100 of the prior art, for example, clearance of 1 mm or more is ensured between the inner thin shaft portion 136 and the first small-diameter section 126. Accordingly, when the inner thin shaft portion 136 passes through the first small-diameter section 126, even if the valve rod 130 is eccentric with respect to the through hole 120, the tip of the inner thin shaft portion 136 hardly interferes with the first small-diameter section 126 of the through hole 120. Therefore, the high-pressure tank 100 of the prior art can eliminate or reduce the possibility of the inner peripheral surface of the first small-diameter section 126 being scratched.

However, when the diameter D4 of the inner thin shaft portion 136 is smaller than the diameter D1 of the outer thick shaft portion 132, a step is generated between the inner thin shaft portion 136 and the outer thick shaft portion 132. In other words, with respect to the radial direction of the valve rod 130, the inner end E10 of the outer thick shaft portion 132 protrudes outward from the outer peripheral surface of the inner thin shaft portion 136. That is, the inner end E10 of the outer thick shaft portion 132 is closer to the inner circumferential surface of the first small-diameter section 126 than the inner thin shaft portion 136. As mentioned above, the inner end E10 of the outer thick shaft portion 132 is generally right-angled and sharp. Therefore, when the valve rod 130 moves inward and the valve rod 130 is eccentric with respect to the through hole 120, as shown in 4B, the inner end E10 of the outer thick shaft portion 132 scratches the opposing section 127 that has passed through the inner peripheral surface of the first small-diameter section 126.

When the valve body of the high-pressure tank 100 of the prior art moves to the closed position P2, the high-pressure tank 100 is closed. As shown in the drawing 4B, in the closed position P2, the seal 140 faces the seal compression section 125. The seal compression section 125 is located inside the opposing section 127. That is, in the closed position P2, the seal 140 does not touch the opposing section 127. Therefore, the scratch on the opposing section 127 does not damage the seal 140.

However, for example, it is assumed that the valve body of the high-pressure tank 100 of the prior art first moves to the compression start position P3 and then moves to the closed position P2 again, or that the valve body of the high-pressure tank 100 of the prior art is replaced and a new valve body moves to the closed position P2. In these cases, the seal 140 is damaged as the seal 140 moves through the opposing section 127 to the seal compression section 125.

Conventionally, it has been considered that the eccentricity of the valve rod 130 is caused by dimensional accuracy in each part, such as a variation in the manufacturing dimension of the through hole 120, a variation in the manufacturing dimension of the valve rod 130, or a variation in the manufacturing dimension of the seal 140. However, the inventors investigated the relationship between the dimensional accuracy of each part and the occurrence of eccentricity of the valve rod 130. Consequently, the inventors have discovered that the main reason for the eccentricity of the valve rod 130 is not due to the dimensional accuracy of the respective portions, but due to the frictional force generated between the seal 140 rotating in the direction of arrow F1 (see FIG. 1) together with the valve rod 130 and the inner peripheral surface of the guide section 124 changing in the circumferential direction of the seal 140. From this finding, the present inventors considered that the occurrence of eccentricity of the valve rod 130 cannot be made zero even if the dimensional accuracy of each of the above-described portions is improved, and sought a structure capable of eliminating or reducing the possibility that the seal 140 being damaged even if the valve rod 130 is eccentric.

Returning to FIG. 2B, the configuration of the high-pressure tank 10 of the present embodiment will be described. When the valve rod 30 is eccentric with respect to the through hole 20, the chamfered portion 37 provided on the distal end E2 of the inner thick shaft portion 36 of the valve rod 30 on the inside space 3 side contacts the second small-diameter section 28 of the through hole 20. Consequently, as shown in the drawing 2B, the inner thick shaft portion 36 scratches the opposing section 27 of the inner circumferential surface of the second small-diameter section 28 that faces the chamfered portion 37. Similarly, when the valve body 13 moves from the closed position P2 to the compression start position P3, the chamfered portion 37 of the valve rod 30 contacts the opposing section 27 of the through hole 20 and scratches the opposing section 27. As shown in 2B, the valve body 13 moves toward the inside space 3 by a distance L1 from the compression start position P3 to the closed position P2. Therefore, the length L2 of the opposing section 27 in which the scratch is made is equal to the distance L1 from the compression start position P3 to the closed position P2.

As described with reference to FIG. 4A and FIG. 4B, when the outer peripheral surface of the seal 40 is pressed against the scratch of the opposing section 27, the seal 40 is damaged. As a result, the seal 40 may not be able to seal the through hole 20. In the high-pressure tank 10 of the present embodiment, the length L3 of the inner thick shaft portion 36 is greater than the distance L1 from the compression start position P3 to the closed position P2. Therefore, in the high-pressure tank 10 of the present embodiment, unlike the high-pressure tank 100 of the prior art, the seal compression section 25 is located outside the opposing section 27. That is, the range in which the distal end E2 of the inner thick shaft portion 36 of the valve body 13 moves and the range in which the seal 40 moves do not overlap each other until the valve body 13 moves from the compression start position P3 to the closed position P2. Therefore, even if a flaw is formed in the opposing section 27 of the inner peripheral surface of the through hole 20 due to the eccentricity of the valve rod 30, the seal 40 can be prevented from coming into contact with the scratch. Therefore, in the high-pressure tank 10 of the present embodiment, the seal 40 is less likely to be damaged by the scratch on the opposing section 27.

Further, in the high-pressure tank 10 of the present embodiment, a chamfered portion 37 is provided on the distal end E2 of the inner thick shaft portion 36. Therefore, when the valve body 13 moves between the compression start position P3 and the closed position P2, the opposing section 27 contacts the chamfered portion 37. Therefore, the opposing section 27 is less likely to be scratched as compared with, for example, a configuration in which the distal end E2 that is not chamfered contacts the opposing section 27 (see the valve rod 30a of the second embodiment).

### Second Embodiment

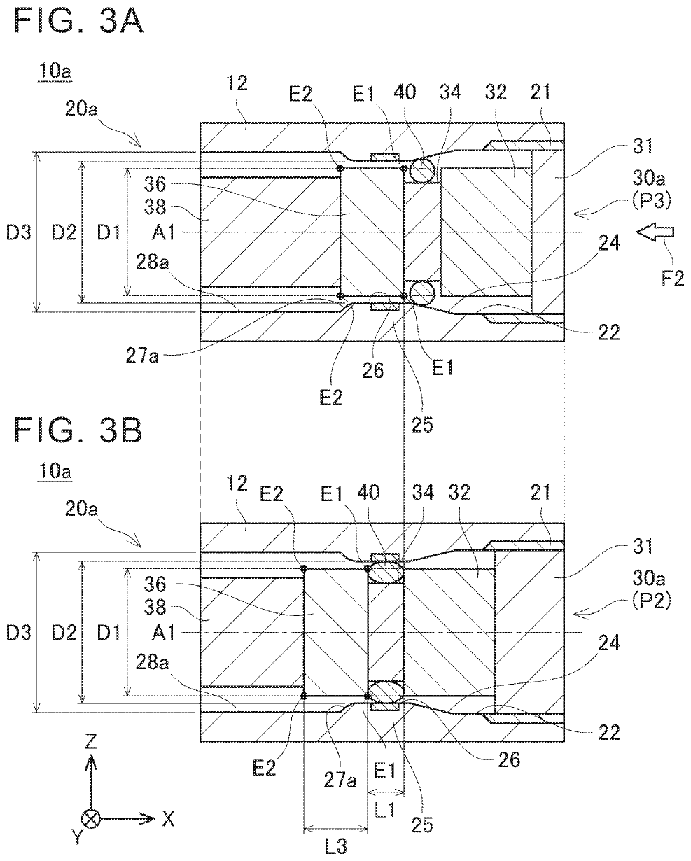

Referring to FIGS. 3A and 3B, a high-pressure tank 10a of a second embodiment will be described. The high-pressure tank 10a of the second embodiment includes a through hole 20a instead of the through hole 20 of the first embodiment, and includes a valve rod 30a instead of the valve rod 30 of the first embodiment. The high-pressure tank 10a of the second embodiment has otherwise the same construction as the high-pressure tank 10 of the first embodiment.

The through hole 20a of the high-pressure tank 10a of the second embodiment includes a chamfered section 27a and a second large-diameter section 28a instead of the second small-diameter section 28. The chamfered section 27a is provided in the end of the first small-diameter section 26 that is located at the boundary between the first small-diameter section 26 and the second large-diameter section 28a. The chamfered section 27a is a so-called R chamfer. In a variant, the chamfered section 27a may be a C-chamfer. The second large-diameter section 28a adjoins the first small-diameter section 26 from the inside space 3 side and has a diameter D3 larger than the diameter D2 of the first small-diameter section 26.

Unlike the valve rod 30 of the first embodiment, the valve rod 30a of the second embodiment does not have a chamfered portion 37. Therefore, the distal end E2 of the inner thick shaft portion 36 is at a right angle.

Like the high-pressure tank 10 of the first embodiment, the high-pressure tank 10a of the second embodiment also has the length L3 of the inner thick shaft portion 36 (i.e., the dimension from the proximal end E1 to the distal end E2 of the inner thick shaft portion 36) that is greater than the distance L1 from the compression start position P3 to the closed position P2. In the high-pressure tank 10a of the second embodiment, in addition to the first small-diameter section 26 in which the seal 40 comes into contact with the seal compression section 25 is provided in the closed position P2, a second large-diameter section 28a adjoining the first small-diameter section 26 from the inside space 3 side and having a diameter D3 larger than the diameter D2 of the first small-diameter section 26 are provided. In the high-pressure tank 10a of the present embodiment, the seal compression section 25 is located outward of the second large-diameter section 28a.

Further, as shown in the drawings and 3A and 3B, even when the valve rod 30 of the valve body 13 is in either the closed position P2 or the compression start position P3, the distal end E2 of the inner thick shaft portion 36 of the valve body 13 faces the second large-diameter section 28a. That is, the distal end E2 of the inner thick shaft portion 36 does not face the first small-diameter section 26 until the valve body 13 moves to the closed position P2 after the seal 40 is started to be compressed. Therefore, the distal end E2 of the inner thick shaft portion 36 is less likely to scratch the first small-diameter section 26 due to the reaction force of the seal 40. Further, by increasing the distance between the distal end E2 of the inner thick shaft portion 36 and the second large-diameter section 28a, the distal end E2 of the inner thick shaft portion 36 is less likely to scratch the second large-diameter section 28a.

Further, as described above, a chamfered section 27a is formed at the end of the first small-diameter section 26 on the inside space 3 side. Therefore, the chamfered section 27a is less likely to scratch the outer peripheral surface of the inner thick shaft portion 36 as compared with a configuration in which the end of the first small-diameter section 26 on the inside space 3 side is at a right angle.

While specific examples of the technology disclosed in the present specification have been described in detail above, these examples are merely illustrative and do not limit the scope of the claims. The technique described in the claims includes various modifications and variations of the specific examples exemplified above. Variations of the above embodiments are listed below.

### First Modification

The fluid that is contained in the inside space 3 of the high-pressure tank 10 is not limited to high-pressure hydrogen, and may be, for example, nitrogen gas, oxygen gas, liquid oxygen, or liquid nitrogen.

### Second Modification

The valve rod 30 of the valve body 13 of the first embodiment may not have the outer thick shaft portion 32. Further, in a further variant, the inner thick shaft portion 36 and the outer thick shaft portion 32 may have different diameters.

### Third Modification

The valve rod 30 of the valve body 13 of the first embodiment may not have the intermediate shaft portion 38. In this case, the inner thick shaft portion 36 may further extend toward the inside space 3.

### Fourth Modification

The valve rod 30a of the valve body 13 of the second embodiment may have a chamfered portion 37.

### Fifth Modification

The through hole 20a of the boss 12 of the second embodiment may not have the chamfered section 27a.

The technical elements described in this specification or in the drawings may be used alone or in various combinations, and are not limited to the combinations described in the claims at the time of filing. In addition, the technique exemplified in the present specification or drawings can achieve a plurality of purposes at the same time, and achieving one of the purposes itself has technical usefulness.

What is claimed is:

1. A high-pressure tank, comprising:
a tank body having an inside space configured to contain a fluid;
a boss located on the tank body and having a through hole that allows the inside space and an outside space of the tank body to communicate with each other;
a valve body housed in the through hole and movable between an open position and a closed position in an axial direction of the through hole, the open position being a position where the through hole is opened, and the closed position being a position where the through hole is closed; and
a ring-shaped seal located on an outer peripheral surface of the valve body, wherein
the outer peripheral surface of the valve body includes, along an axial direction of the valve body, a groove portion where the seal is located, and
a thick shaft portion adjoining the groove portion from the inside space side and having a larger diameter than the groove portion, and
a length of the thick shaft portion is greater than a distance from a compression start position to the closed position, the compression start position being defined as a position where compression of the seal is started in a stroke in which the valve body moves from the open position to the closed position.

2. The high-pressure tank according to claim 1, wherein the outer peripheral surface of the valve body further includes, along the axial direction of the valve body, a second thick shaft portion adjoining the groove portion from the outside space side and having the same diameter as the thick shaft portion.

3. The high-pressure tank according to claim 1, wherein a distal end of the thick shaft portion is chamfered, the distal end being an end located distal to the groove portion.

4. The high-pressure tank according to claim 1, wherein:
an inner peripheral surface of the through hole includes, along the axial direction of the through hole, a first section having a first diameter and a second section having a diameter larger than the first diameter, the first section being a section in which the seal contacts in the closed position, and the second section being a section adjoining the first section from the inside space side; and
when the valve body is located at the closed position or the compression start position, the distal end of the thick shaft portion that is located distal to the groove portion faces the second section of the through hole.

5. The high-pressure tank according to claim 4, wherein an end of the first section that is located at a boundary between the first section and the second section is chamfered.
